(19) United States
(12) Patent Application Publication
(10) Pub. No.: US 2014/0034346 A1
(43) Pub. Date: Feb. 6, 2014

(54) SPEED CONTROL DEVICE FOR GOVERNING THE SPEED OF A PNEUMATIC POWER TOOL

(71) Applicants: Dan Eklund, Taby (SE); Ulf Mikael Eriksson, Vallentuna (SE)

(72) Inventors: Dan Eklund, Taby (SE); Ulf Mikael Eriksson, Vallentuna (SE)

(73) Assignee: ATLAS COPCO INDUSTRIAL TECHNIQUE AB, Stockholm (SE)

(21) Appl. No.: 14/110,878

(22) PCT Filed: Apr. 13, 2012
(86) PCT No.: PCT/EP2012/056776

§ 371 Date: Oct. 9, 2013

(30) Foreign Application Priority Data
Apr. 20, 2011 (SE) 1150353-9

(51) Int. Cl. B25F 5/00

(52) U.S. Cl. CPC B25F 5/00
USPC 173/179

(57) ABSTRACT

A speed control device for limiting the idle and operating speed of a pneumatic power tool driven by an air turbine (20) and comprising an inlet passage (16) for supplying pressure air at a pressure (P1), one or more nozzles (25) for directing supplied motive pressure air onto the turbine wheel (22) of the air turbine (20), and a speed governor (21) with a movable valve element (43) biased by a turbine speed responsive control pressure (P3) and arranged to control the flow of supplied pressure air from the pressure air inlet passage (16) to the nozzles (25), wherein a pressure regulator (60) controlled by the pressure air supply pressure (P1) is arranged to adjust the control pressure (P3) by adjusting the size of a bleed passage (66) communicating with the atmosphere in response to the actual level of the pressure air supply pressure (P1) such that a decreasing pressure air supply pressure (P1) results in an decreased area of the bleed passage (66) and a following increased control pressure which results in an increased pressure air flow to the turbine nozzles (25) and a compensation for occurring variations in the pressure air supply pressure (P1).

The invention relates to a speed control device for governing the idle speed of a pneumatic power tool, in particular a pneumatic power tool comprising an air turbine.

In power tools of the above described type, usually used for grinding applications, it is of the greatest importance that the rotation speed is kept down to a predetermined safe level so as to avoid serious damage to people and equipment. In grinding applications in particular there is a great risk for grinding wheel explosion if the rotation speed reaches levels where the material in the grinding wheel is unable to withstand the centrifugal forces.

In a prior art turbine grinder, described in U.S. Pat. No. 5,314,299, there is used a speed governor comprising a valve element located in a pressure air inlet passage and activated by a control pressure obtained via an idle running nozzle. This control pressure is obtained via a pressure sensing opening located opposite the idle running nozzle and is communicated to the speed governor valve element to obtain a balancing of the latter between the control pressure and the pressure in the pressure air inlet passage, such that when the rotation speed of the turbine is lowering the valve element is moved in its opening direction and, oppositely, when the rotation speed is increasing the valve is moved in its closing direction. This is due to the fact that the control pressure emanating from the pressure sensing opening at the turbine wheel decreases as the rotation speed increases.

A problem concerned with this known speed governor relates to its dependency on the pressure air supply pressure, which means that a higher air supply pressure results in a higher idle speed of the turbine and a lower air supply pressure gives a lower idle speed. For safety reasons the governor will be initially adjusted to make the turbine operate at a certain safe idle speed level at normal air supply pressure, for instance 7 bar. Such a certain idle speed, which is substantially the same as the operating speed during normal work, is favourable as regard grinding efficiency as well as mechanical wear of the grinding wheel attached to the grinder. A reduced air pressure and a following lower idle and operation speed does not create any risk for grinding wheel explosion, but it is disadvantageous in that the grinder wheel will be exposed to an excessive wear during operation. A too low idle and operating speed also causes an undesirably low grinding efficiency.

It is an object of the invention to provide a speed control device for governing the idle speed of a pneumatic tool including an air turbine, wherein a means is provided to avoid turbine idle speed dependency on occurring variations in the pressure air supply pressure.

It is a further object of the invention to provide a speed control device for governing the idle speed of a pneumatic power tool including an air turbine and comprising speed governor with a valve element balanced between the supply pressure of the motive pressure air and a speed related control pressure created in a pressure sensing opening adjacent the turbine wheel, wherein a means is provided to adjust the control pressure so as to avoid turbine idle speed dependency on occurring variations in the pressure air supply pressure.

Still further objects and advantages of the invention will appear from the following specification and claims.

A preferred embodiment of the invention is described below with reference to the accompanying drawings.

In the drawings

FIG. 1 shows partly in section, a side view of an air turbine driven power tool comprising a speed control device according to the invention.

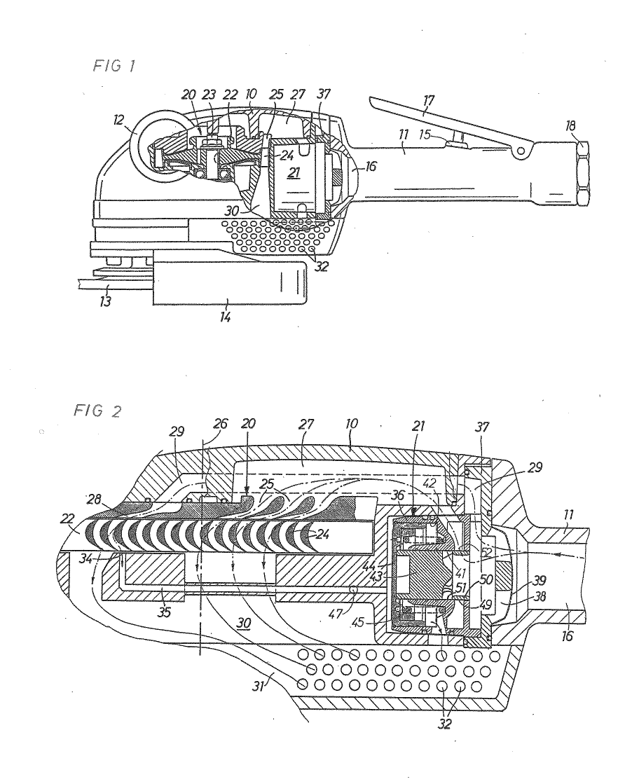

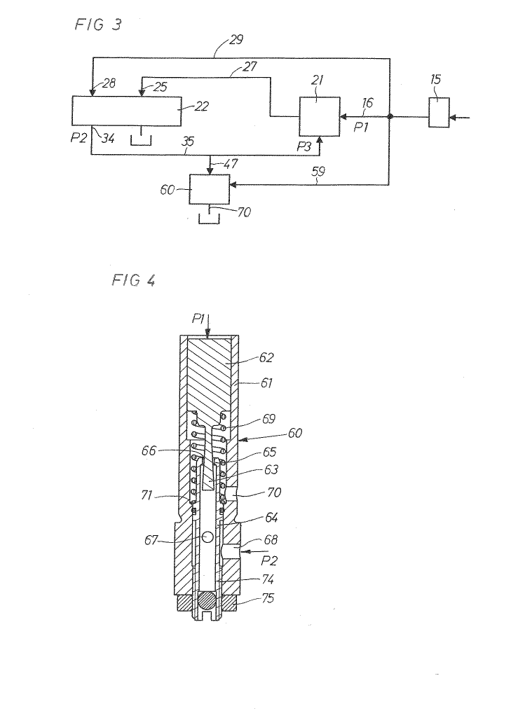

FIG. 2 shows schematically the speed control device according to the invention including an illustration of the pressure air flow paths through the turbine nozzles and governor valve.

FIG. 3 shows diagrammatically the speed control device according to the invention.

FIG. 4 shows a section through a control pressure regulator according to the invention.

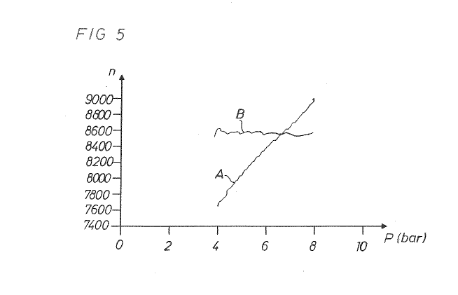

FIG. 5 shows a diagram illustrating the idle speed as a function of the pressure air supply pressure.

In FIG. 1 there is shown a pneumatic angle grinder which comprises a housing 10 provided with two handles 11, 12, an output shaft (not shown) carrying a grinding wheel 13, and a grinding wheel safety guard 14.

One of the handles 11 comprises a pressure air inlet passage 16, a throttle valve 15 controlled via a lever 17, and a conduit connection 18 for a pressure air supply conduit.

The grinder further comprises a motor in the form of an action type air turbine 20 with a turbine wheel 22, a speed governor valve unit 21, and a reduction gearing (not shown) coupling the turbine wheel 22 to the output shaft.

The turbine wheel 22 is mounted on a shaft 23 and comprising a peripheral row of blades 24, and a number of nozzles 25 are provided in the housing 10 for directing motive pressure air onto the turbine wheel blades 24 to rotate the turbine wheel 22 about an axis 26. An air feed passage 27 extends between the speed governor valve unit 21 and the nozzles 25, and a separate idle running nozzle 28 communicates directly with the inlet passage 16 upstream of the speed governor valve unit 21 via a passage 29. See FIG. 2. An exhaust air passage 30 extends from the turbine wheel 22 to an outlet and a silencing chamber 31 which communicates with the atmosphere through a number of apertures 32.

Opposite the idle running nozzle 28 and downstream of the turbine wheel 22 there is located a pressure sensing opening 34 which via a control pressure passage 35 communicates with the speed governor valve unit 21.

The speed governor valve unit 21 comprises a casing 36 mounted in the housing 20, and an end cover 37 provided with inlet openings 38, and a wire net screen 39. The casing 36 is formed with two bores 41 and 42 of different diameters which guidingly support a valve element 43 and an activating piston 44, respectively. The valve element 43 has a rear sleeve shaped portion 50 with lateral openings 51 which in the open position of the valve element 43 coincide with outlet openings 52 in the valve casing 36 and open up a communication between the inlet passage 16 and the air feed passage 27. The valve element 43 is balanced between the inlet pressure P1 and the load of a compression spring 45 on one side and the control pressure in passage 35 on the other side.

The grinder further comprises a pressure regulator 60 (not illustrated in FIGS. 1 and 2) for adjusting the control pressure in the passage 35 in response to the actual pressure in the pressure air inlet passage 16. The pressure regulator 60 is described in further detail below. A passage 47 is arranged to provide communication between the control pressure passage 35 and the pressure regulator 60.

As schematically illustrated in FIG. 3, the air pressure in the inlet passage 16 is designated P1 and is communicated directly to the idle running nozzle 28 via the passage 29. This means that as long as the throttle valve 15 is open the idle running nozzle 28 is active in driving the turbine at an idle speed at low power. At the downstream side of the turbine wheel 22 the pressure sensing opening 34 will be hit by the outlet flow from the idle running nozzle 28 downstream of the turbine wheel 22 and create a control pressure P2. This control pressure P2 is dependent on the flow direction of this outlet flow in dependency of the actual rotation speed of the turbine wheel 22, because only at a certain predetermined speed level the outlet flow will hit the sensing opening 34 spot on. This is obtained in that the pressure sensing opening 34 is located so as to give the highest control pressure at the desired idle speed level. Accordingly, at the start of the turbine the control pressure is low, and the speed governor valve element 43 is closed. As the idle speed reaches the desired level the control pressure P2 is high enough to urge the valve element 43 toward open position, wherein the lateral openings 51 coincide with the outlet openings 52 to let through an air flow to the main nozzles 25. At this point the turbine gets full power, but an increase of the speed above the predetermined idle speed will cause the outlet flow from the idle nozzle 28 downstream of the turbine wheel not to hit the pressure sensing opening 34 which means that the control pressure P2 in passage 35 will be substantially reduced. This reduced control pressure load on the activation piston 44 will allow the inlet pressure P1 and the load of the spring 45 to displace the valve element 43 toward closed position to, thereby accomplish a limitation of the idle speed to the desired level.

At application of a work load on the grinding wheel 13 the rotation speed of the turbine 21 tends to decrease from its desired idle speed, which means that the control pressure

P2 is somewhat decreased and the control pressure force acting on the activation piston 44 and the valve element 43 is decreased as well. This makes the valve element 43 move in an opening direction by the action of the inlet pressure P1 and the load of spring 45 to thereby increase the air flow to the nozzles 25 and keep up the rotation speed at the desired level.

In order to avoid the influence of occurring variations in the inlet pressure P1 on the idle speed of the turbine 21 there is employed a pressure regulator 60 to adjust the control pressure acting on the activation piston 44. The pressure regulator 60 is arranged to selectively bleed out to the atmosphere certain amounts of air from the control pressure passage 35 in relation to the actual level of the pressure air supply pressure P1 as communicated via a passage 59. See FIG. 3. To that end the pressure regulator 60 is provided with an outlet opening 70 which communicates continuously with the atmosphere. The tendency is that a higher pressure air supply pressure P1 in the inlet passage 16 the higher the idle speed will be, and oppositely, a reduced supply pressure P1 results in an undesirable lower idle speed. This is illustrated in FIG. 5 where the curve A illustrates the idle speed variations at variations in the pressure air supply pressure P1 at prior art turbine grinders without any control pressure regulator, whereas curve B illustrates the idle speed variations when using a control pressure regulator in accordance with the invention. It is clearly illustrated by the curve B that the employment of a control pressure regulator prevents the idle speed of the turbine from be dependent on the actual pressure air supply pressure.

As shown in FIG. 4 the control pressure regulator 60 comprises a valve cylinder 61, and a valve spindle 62 displaceably guided in the cylinder 61 and having a conical end portion 63. The valve spindle 62 is balanced between the inlet pressure P1 and a spring 69 acting between the valve spindle 62 and a shoulder 71 in the valve cylinder 61. The conical end portion 63 of the valve spindle 62 extends into a valve sleeve 64 and is arranged to cooperate with an annular shoulder 65 of the valve sleeve 64 to form an adjustable annular air bleed passage 66 through which a depressurizing air flow can pass to the atmosphere.

The valve cylinder 61 has a lateral opening 68 which communicates with the control pressure passage 35 via the passage 47, and an aperture 67 on the valve sleeve 64. Accordingly, the control pressure P2 can reach the inside of the valve sleeve 64 via the opening 68 and the aperture 67, and an adjustable outlet flow of air may be established through the bleed passage 66 formed between the conical end portion 63 of the valve spindle 62 and the shoulder 65 in the valve sleeve 64. The space between the valve sleeve 64 and the valve cylinder 61 is continuously connected to the atmosphere via an outlet opening 70.

The operation order of the speed control device including the pressure regulator arrangement according to the invention is the following:

Initially, a basic setting of the pressure regulator 60 to compensate for manufacturing tolerances is accomplished by adjusting the axial position of the valve sleeve 64 relative to the valve cylinder 61. This is obtained by loosening the lock nut 75 and rotating the valve sleeve 64, whereby the threaded rear end portion 74 of the valve sleeve 64 cooperates with a thread in the valve cylinder 61. As a satisfactory axial position of the valve sleeve 64 corresponding to a desired idle speed of the turbine at a normal pressure air supply pressure is found the lock nut 75 is tightened. The axial position of the valve sleeve 64 determines the air bleed gap 66 obtained between the shoulder 65 in the valve sleeve 64 and the valve spindle end portion 63.

When starting the turbine the throttle valve 15 is opened and pressure air at an inlet pressure P1 is supplied via the inlet passage 16. The inlet pressure P1 is transferred not only to the speed governor valve unit 21 but also directly to the idle running nozzle 28 to start rotating the turbine 20, and to the control pressure regulator 60.

In the latter the inlet pressure P1 will act on the rear end of the valve spindle 62 which in dependency of the actual level of the inlet pressure P1 will open up a bleed flow to the atmosphere. Due to the shape of the conical end portion 63 of the valve spindle 62 a higher pressure air supply pressure P1 will make the valve spindle 62 move farther into the valve sleeve 64, against the force of the spring 69, to thereby open up the bleed gap 66. A flow of air from the control pressure passage 35 enters the valve cylinder 61 via the passage 47, the opening 68 and the aperture 67 and is bled off to the atmosphere via the bleed gap 66 and the outlet opening 70. This means that the control pressure P2 in the passage 35 is reduced to P3 to act on the activation piston 44 of the governor unit 21. This results in turn that the governor valve 43 tends to move somewhat toward its closed position and, hence, let through a reduced air flow to the nozzles 25 to thereby keep down the idle and operating speed of the turbine 20.

Oppositely, a lower air supply pressure P1 will not urge the valve spindle 62 long enough into the valve sleeve 64 to open up no more than just a very tiny bleed gap or no bleed gap at all. This means that the control pressure P2 is substantially maintained all the way from the pressure sensing opening 34 to the activating piston 44 of the speed governor valve unit 21, which means that P2 will be substantially equal to P3. In this position of the pressure regulator valve spindle 62 and a maintained control pressure P2 the governor valve element 43 will let through a larger pressure air flow to the nozzles 25 to increase the operating speed of the turbine 20.

The end result is that the turbine 20 will operate at substantially the same idle and operating speed no matter the actual level of the pressure air supply pressure P1. To illustrate the advantage gained by the pressure regulator arrangement according to the invention the diagram in FIG. 5 shows two curves, whereof curve A illustrates the variation in idle and operating speed of the turbine 20 at different air supply pressure levels at a turbine driven power tool without any control pressure regulation. In contrast, curve B illustrates how the idle and working speed of the turbine 20 is kept almost constant, despite occurring variations in the pressure air supply pressure P1 when employing a control pressure regulator arrangement according to the invention.

Accordingly, a reduced pressure air supply pressure P1 will not cause any reduced idle or operating speed of the turbine 20 which would have resulted in an undesirably high mechanical wear of the grinding wheel and an impaired working efficiency.

It is to be understood that the invention is not limited to the shown and described example but can be varied within the scope of the claims.

1. Speed control device for controlling the speed of a pneumatic power tool including a housing (10) with a pressure air inlet passage (16), an air turbine (20) with a turbine wheel (22) drivingly coupled to an output spindle, and one or more air nozzles (25) arranged in the housing (10) for directing a flow of pressure air onto the turbine wheel (22), a pressure activated speed governor (21) comprising a valve element (43) that is balanced between the air pressure (P1) in the air inlet passage (16) and a turbine speed responsive control pressure (P3) supplied to the speed governor (21) via a control pressure passage (35), wherein a control pressure regulator (60) is arranged to communicate on one side with the control pressure passage (35) and on the other side with the air inlet passage (16) upstream of the speed governor (21), and the control pressure regulator (60) is arranged to adjust the control pressure (P3) in response to the actual level of the pressure in the air inlet passage (16).

2. Speed control device according to claim 1, wherein the control pressure regulator (60) comprises an adjustable bleed passage (66) for selectively connecting the control pressure passage (35) to the atmosphere to thereby adjust the control pressure (P3).

3. Speed control device according to claim 2, wherein the control pressure regulator (60) comprises a movable valve spindle (62) which is balanced between the pressure (P1) in the air inlet passage (16) and a spring (69).

4. Speed control device according to claim 3, wherein the control pressure regulator (60) comprises a valve sleeve (64) with an annular shoulder (65), and the movable valve spindle (62) has a conical end portion (63) arranged to cooperate with the annular shoulder (65) to form said adjustable bleed passage (66).
